(19) United States
(12) Patent Application Publication
(10) Pub. No.: US 2016/0119860 A1
(43) Pub. Date: Apr. 28, 2016

(54) SLOTTED CELL SEARCH IN HYBRID DATA IN MULTI-SIM DEVICES

(71) Applicant: Samsung Electronics Co., Ltd., Gyeonggi-do (KR)

(72) Inventor: Vivek CHAWLA, Bangalore (IN)

(73) Assignee: Samsung Electronics Co., Ltd.

(21) Appl. No.: 14/925,533

(22) Filed: Oct. 28, 2015

(30) Foreign Application Priority Data
Oct. 28, 2014 (IN) 5369/CHE/2014

(51) Int. Cl. H04W 48/16

(52) U.S. Cl. CPC H04W 48/16; H04W 88/06

(57) ABSTRACT

A device for and a method of optimizing slotted cell search by a multi-subscriber identity module (multi-SIM) device is provided. The method includes performing a packet-based activity on a first SIM of the multi-SIM device for a first timeslot provided by a first timer, performing a cell-search activity on a second SIM of the multi-SIM device for a second timeslot provided by the second timer; and performing the packet-based activity for the first timeslot and the cell-search activity for the second timeslot by alternately switching between the first timer and the second timer.

### PRIORITY

This application claims priority under 35 U.S.C. §119(a) to an Indian Provisional Patent Application filed on Oct. 28, 2014 in the Indian Intellectual Property Office and assigned Serial No. 5369/CHE/2014, and an Indian Complete Patent Application filed on Sep. 14, 2015 in the Indian Intellectual Property Office and assigned Serial No. 5369/CHE/2014, the entire contents of each of which are incorporated herein by reference.

### BACKGROUND

1. Field of the Disclosure

The present disclosure generally relates to wireless communications systems, and more particularly, to wireless wide area network (WWAN) devices supporting standby receive mode for multiple subscriptions/subscriber identity modules (SIMs) with single radio frequency (RF) transceiver, for instance, dual SIM and triple SIM cellphones.

2. Description of the Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

A multi-SIM multi-standby device supporting hybrid data allows packet data operation on one subscription (e.g. on SIM 1) and, in parallel, idle mode operations like page monitoring, system information reading, cell search, measurements on another subscription (e.g. on SIM 2). Each occurrence of idle mode operation on another subscription results in a temporary pause of data operation on the first subscription as there is only one RF transceiver shared across all subscriptions. Typically, idle mode operations are short duration so the temporary drop in a first subscription's data throughput is not perceivable by a user at the application level.

However, a cell search operation can take multiple seconds or minutes causing a disruption to a user data session. The conventional way of doing a cell search operation is a one-shot approach where all the required frequencies (e.g. across one or more bands) are scanned and searched in a contiguous manner. The amount of time taken by this search depends on the number of frequencies scanned, the RF conditions/interference, the type of search, etc. Given that today's WWAN devices support multiple bands for each technology, the cell search time can easily run into minutes in dense RF conditions (e.g. multiple operators transmitting on multiple frequencies in different bands and for different technologies/remote access terminals (RATs)). The discontinuity in a data session on a first subscription due to this cell search duration is sufficiently long to cause data disruption for a user at the application level and degrade the user experience.

In view of the foregoing, there is a need for an improved cell search scheme for hybrid data to avoid disruption of a user data session.

### SUMMARY

An aspect of the present disclosure provides a dual subscriber identity module (dual-SIM) device and a method of optimizing slotted cell search by a dual-SIM device.

Another aspect of the present disclosure provides an RF resource that is shared between a first SIM during a first time slot and a second SIM during a second time slot.

Another aspect of the present disclosure provides that a duration of a first time slot and a duration of a second time slot are dynamically adjustable to control a cell search operation.

According to an aspect of the present disclosure, a method of optimizing slotted cell search by a multi-SIM device is provided. The method includes performing a packet-based activity on a first SIM of the multi-SIM device for a first timeslot provided by a first timer; performing a cell-search activity on a second SIM of the multi-SIM device for a second timeslot provided by the second timer; and performing the packet-based activity for the first timeslot and the cell-search activity for the second timeslot by alternately switching between the first timer and the second timer.

According to another aspect of the present disclosure a multi-SIM device is provided. The multi-SIM device includes a first SIM, a second SIM, a first timer, a second timer, and a controller configured to perform a packet-based activity on the first SIM for a first timeslot provided by the first timer, perform a cell-search activity on the second SIM for a second timeslot provided by the second timer; and switch between the first timer and the second timer to alternately perform the packet-based activity for the first timeslot and the cell-search activity for the second timeslot.

According to another aspect of the present disclosure a chipset is provided. The chipset is configured to perform a packet-based activity on a first SIM of the multi-SIM device for a first timeslot provided by a first timer; perform a cell-search activity on a second SIM of the multi-SIM device for a second timeslot provided by the second timer; and perform the packet-based activity for the first timeslot and the cell-search activity for the second timeslot by alternately switching between the first timer and the second timer.

According to another aspect of the present disclosure, a non-transitory computer-readable recording medium storing instructions configured to perform a method by a processor is provided. The method includes performing a packet-based activity on a first SIM of the multi-SIM device for a first timeslot provided by a first timer; performing a cell-search activity on a second SIM of the multi-SIM device for a second timeslot provided by the second timer; and performing the packet-based activity for the first timeslot and the cell-search activity for the second timeslot by alternately switching between the first timer and the second timer.

### BRIEF DESCRIPTION OF THE DRAWINGS

The above and other aspects, features and advantages of the present disclosure will be more apparent from the following detailed description, taken in conjunction with the accompanying drawings, in which:

FIG. 1 is a flow diagram of a slotted cell search in hybrid data a dual-SIM device, according to an embodiment of the present disclosure;

FIG. 2 is a block diagram of a dual-SIM device, according to an embodiment of the present disclosure; and

FIG. 3 is a flowchart of a method of performing a slotted cell search by a dual-SIM device, according to an embodiment of the present disclosure.

### DETAILED DESCRIPTION OF EMBODIMENTS OF THE PRESENT DISCLOSURE

The present disclosure discloses a method of optimizing slotted cell search in hybrid data in devices supporting standby receive mode for multiple subscriptions with a single RF transceiver, such as dual-SIM and multi-SIM devices. In the following detailed description of the embodiments of the present disclosure, reference is made to the accompanying drawings that form a part hereof, and in which are shown by way of illustration certain embodiments in which the present disclosure may be practiced. The embodiments of the present disclosure are described in sufficient detail to enable those skilled in the art to practice the present disclosure, and it is to be understood that other embodiments may be utilized and that changes may be made without departing from the scope and spirit of the present disclosure. The following detailed description is, therefore, not to be taken in a limiting sense, and the scope of the present disclosure is defined only by the appended claims and their equivalents.

The foregoing has outlined, in general, the various aspects of the present disclosure and is an aid in understanding the detailed description below. In reference to such, there is a clear understanding that the present disclosure is not limited to the method or application of use described and illustrated herein. It is intended that the present disclosure include any other advantages and objects that are within the scope and spirit of the present disclosure as defined by the appended claims and their equivalents.

Although certain features of the present disclosure are shown in some of the accompanying drawings but not in others, this is done for convenience only as each feature may be combined with any or all of the other features in accordance with the present disclosure.

According to an embodiment of the present disclosure, a slotted cell search is implemented using two timers in radio resource control (RRC) which is in Layer 3 in a wireless protocol stack and is also known by other names such as radio resource (RR), radio resource management (RRM), etc. A first timer is initiated for a first time slot, TsearchOn, and a second timer is activated for a second time slot, TsearchOff. An RF resource is shared between packet data on a first SIM for a first time slot and a cell search on a second SIM for a second time slot. The RRC layer runs the first timer.

An RF resource is shared between packet data on a first subscription (e.g. for a TsearchOff duration) and a cell search on other subscription (e.g. for a TsearchOn duration). The RRC layer runs a first timer and a second timer in alternate fashion, i.e. TsearchOn followed by TsearchOff followed by TsearchOn, and so on. Association of the first timer and the second timer to a certain layer in a stack is implementation dependent and can be different in different implementations.

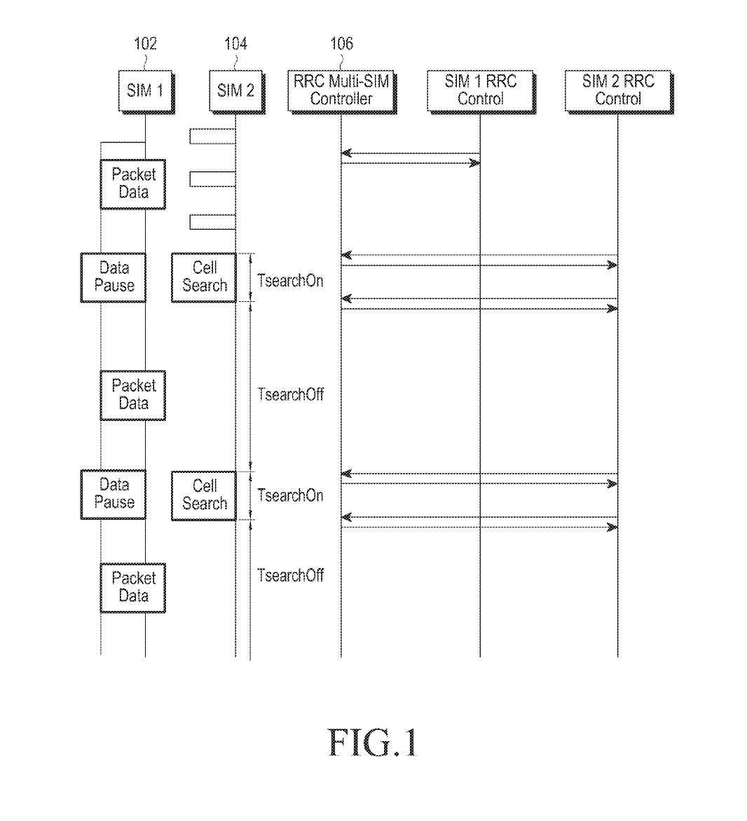

FIG. 1 is a flow diagram of a slotted cell search in hybrid data in a dual-SIM device, according to an embodiment of the present disclosure.

Referring to FIG. 1, in an embodiment of the present disclosure, the slotted cell search scheme is described in view of a first SIM (SIM 1) 102 being in a packet data reception mode and a second SIM (SIM 2) 104 needing an RF resource temporarily for an idle mode operation.

This indicates that the cell search occurs for the second SIM 104 when data activity happens in the first SIM 102.

The cell search operation herein is divided into periodic fixed duration search slots. The first SIM 102 uses the RF resource, which is an RF transceiver, during the time between consecutive search slots of the second SIM 104 for reception of data packets. This approach ensures that the RF transceiver is not taken away from the first SIM 102, for an extended period of time, thereby ensuring hybrid data throughput and a good user experience.

According to FIG. 1, a slotted cell search is implemented using a first timer, TsearchOn, and a second timer, TsearchOff, in the RRC layer. The RRC layer is in Layer 3 in wireless protocol stack and is also known by other names as RR, RRM, etc. The RF transceiver is shared between packet data on the first SIM 102 for a first time slot (e.g. for a TsearchOff duration) and a cell search on the second SIM 104 for a second time slot (e.g. for a TsearchOn duration). The RRC multi-SIM controller 106 alternates the first time slot and the second time slot to control the cell search operation.

The slotted cell search is similarly applicable, when the second SIM 104 is in packet data reception mode and the first SIM 102 needs the RF transceiver temporarily for an idle mode operation.

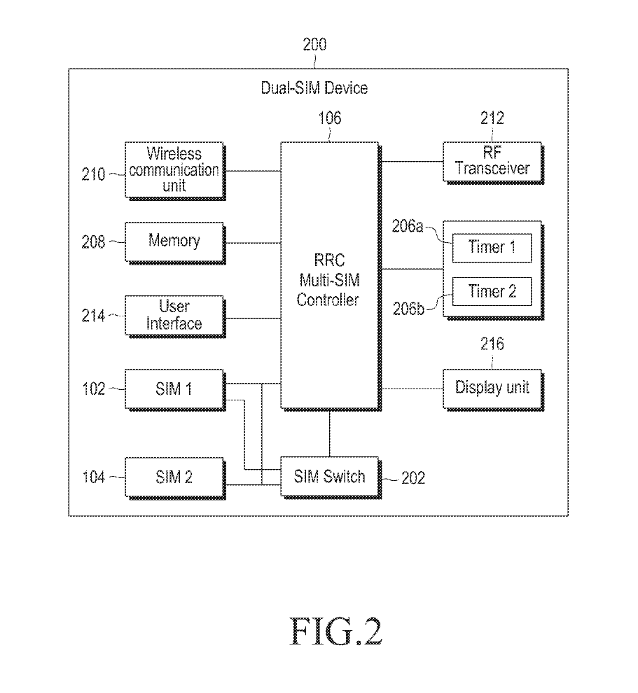

FIG. 2 is a block diagram of a dual-SIM device 200, according to an embodiment of the present disclosure.

Referring to FIG. 2, the dual-SIM device 200 includes a first SIM (SIM 1) 102, a second SIM (SIM 2) 104, a SIM switch 202, an RRC multi-SIM controller 106, a first timer (Timer 1) 206a, a second timer (Timer 2) 206b, a memory 208, a wireless communication unit 210, an RF transceiver 212, a user interface 214 and a display unit 216. However, the constituent elements as illustrated in FIG. 2 are not necessarily required, and the dual-SIM device 200 may be implemented with a greater or lesser number of elements than the illustrated elements.

According to FIG. 1, the slotted cell search is implemented using the Timer 1 206a and the Timer 2 206bin the RRC layer. The RRC layer is in Layer 3 in a wireless protocol stack and is also known RR, RRM, etc. The RF transceiver 212 is shared between packet data on the first SIM 102 for a first time slot (e.g. for a TsearchOff duration) and a cell search on the second SIM 104 for a second time slot (e.g. for a TsearchOn duration). The RRC multi-SIM controller 106 alternates the first time slot and the second time slot to control the cell search operation.

The first SIM 102 and the second SIM 104 are selectively connected to the RRC multi-SIM controller 106 through the SIM switch 202. The RRC multi-SIM controller 106 controls to perform SIM switching between the first SIM 102 and the second SIM 104 when the first SIM 102 and the second SIM 104 provide different services, thereby providing a user's desired service through the RF transceiver 212.

The wireless communication unit 210 includes one or more modules allowing radio communication between the dual-SIM device 200 and a wireless communication system, or allowing radio communication between the dual-SIM device 200 and a network in which the dual-SIM device 200 is located.

The user interface 214 interfaces with all external devices connected to the dual-SIM device 200. The user interface 214 may include, for example, wired/wireless headset ports, external charger ports, wired/wireless data ports, memory card ports, ports for coupling devices having an identification module, audio input/output (I/O) ports, video I/O ports, earphone ports, and the like.

The display unit 216 may display (e.g. output) information processed in the dual SIM device 200. For example, when the dual-SIM device 200 is in a phone call mode, the display unit 216 may display a user interface (UI) or a graphical user interface (GUI) associated with a call

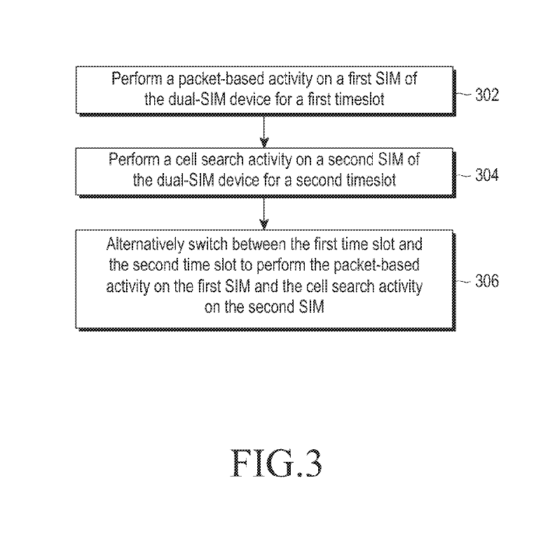

FIG. 3 is a flowchart of a method of performing a slotted cell search by a Dual-SIM device, according to an embodiment of the present disclosure.

Referring to FIG. 3, in step 302, the dual SIM device performs a packet-based activity on a first SIM of a dual-SIM device for a first timeslot provided by a first timer.

In step 304, the dual-SIM device performs a cell-search activity on a second SIM for a second timeslot provided by a second timer.

In step 306, the dual SIM device performs the packet-based activity for the first timeslot and the cell-search activity for the second timeslot by alternately switching between the first timer and the second timer.

Although only an RF transceiver has been described above as a resource for cell search, it is to be understood that the slotted cell search scheme is applicable in the same way to any common resource that may be needed by the first SIM and the second SIM, e.g., a temperature compensated crystal oscillator (TCXO), which is typically a single clock source in such wireless devices.

According to an embodiment of the present disclosure, a slotted cell search herein is not limited to dual-SIM devices but can be extended to any multi-SIM device.

The slotted cell search in hybrid data provides for a better user experience of hybrid data in a dual-SIM device, as the impact on data throughput by the cell search operation on the second SIM is minimal. Further, the present disclosure provides tune-able performance of a hybrid data scenario as the timers TsearchOn and TsearchOff are adjusted for better data throughput or faster cell search. This indicates that the second time slot for which the RRC scans frequencies on the second SIM for cell search is increased or decreased to minimize interruptions on the data search activity of the first SIM and vice versa. The slotted cell search scheme of the present disclosure is a simple, robust and optimal scheme which is applicable to all radio access technologies such as 2G, 3G, 4G and so on.

In an embodiment of the present disclosure, a chipset is provided. The chipset is configured to perform a packet-based activity on a first SIM of the multi-SIM device for a first timeslot provided by a first timer; perform a cell-search activity on a second SIM of the multi-SIM device for a second timeslot provided by the second timer; and perform the packet-based activity for the first timeslot and the cell-search activity for the second timeslot by alternately switching between the first timer and the second timer.

In an embodiment of the present disclosure, a non-transitory computer-readable recording medium storing instructions configured to perform a method by a processor is provided. The method includes performing a packet-based activity on a first SIM of the multi-SIM device for a first timeslot provided by a first timer; performing a cell-search activity on a second SIM of the multi-SIM device for a second timeslot provided by the second timer; and performing the packet-based activity for the first timeslot and the cell-search activity for the second timeslot by alternately switching between the first timer and the second timer.

While the present disclosure is described herein with certain embodiments, it will be obvious to a person skilled in the art to practice the present disclosure with modifications. However, all such modifications may be within the scope and spirit of the present disclosure as defined by the appended claims and their equivalents.

What is claimed is:

1. A method of optimizing slotted cell search by a multi-subscriber identity module (multi-SIM) device, comprising:
performing a packet-based activity on a first SIM of the multi-SIM device for a first timeslot provided by a first timer;
performing a cell-search activity on a second SIM of the multi-SIM device for a second timeslot provided by the second timer; and
performing the packet-based activity for the first timeslot and the cell-search activity for the second timeslot by alternately switching between the first timer and the second timer.

2. The method of claim 1, wherein a radio frequency (RF) resource is shared between the first SIM during the first time slot and the second SIM during the second time slot.

3. The method of claim 1, wherein a duration of the first time slot and a duration of the second time slot are dynamically adjustable to control the cell search operation.

4. The method of claim 1, wherein the multi-SIM is a dual-SIM.

5. The method of claim 1, wherein the first timer and the second timer are each a timer in a radio resource control (RRC) layer.

6. The method of claim 3, wherein each of the first timeslot and the second timeslot is periodic and of a fixed duration.

7. A multi-subscriber identity module (multi-SIM) device, comprising:
a first SIM;
a second SIM;
a first timer;
a second timer; and
a controller configured to:
perform a packet-based activity on the first SIM for a first timeslot provided by the first timer;
perform a cell-search activity on the second SIM for a second timeslot provided by the second timer; and
switch between the first timer and the second timer to alternately perform the packet-based activity for the first timeslot and the cell-search activity for the second timeslot.

8. The device of claim 7, wherein the controller is further configured to share a radio frequency (RF) resource between the first SIM during the first time slot and the second SIM during the second time slot.

9. The device of claim 7, wherein the multi-SIM is a dual-SIM.

10. The device of claim 7, wherein a duration of the first time slot and a duration of the second time slot are dynamically adjustable to control the cell search operation.

11. The device of claim 7, wherein each of the first timer and the second timer is a timer in a radio resource control (RRC) layer.

12. The device of claim 11, wherein each of the first timeslot and the second timeslot is periodic and of a fixed duration.

13. The device of claim 9, wherein the dual-SIM further comprises:
a wireless communication unit;
a memory;
a user-interface;
a SIM switch;
a radio frequency (RF) transceiver; and
a display unit.

14. The device of claim 13, wherein the user-interface is comprised of at least one of a wired/wireless headset port, an external charger port, a wired/wireless data port, a memory card port, a port for a coupling device having an identity module, an audio input/output port, a video input/output port, and an earphone port.

15. A chipset, configured to:
perform a packet-based activity on a first SIM of the multi-SIM device for a first timeslot provided by a first timer;
perform a cell-search activity on a second SIM of the multi-SIM device for a second timeslot provided by the second timer; and
perform the packet-based activity for the first timeslot and the cell-search activity for the second timeslot by alternately switching between the first timer and the second timer.

16. The chipset of claim 15, wherein a radio frequency (RF) resource is shared between the first SIM during the first time slot and the second SIM during the second time slot.

17. The chipset of claim 15, wherein a duration of the first time slot and a duration of the second time slot are dynamically adjustable to control the cell search operation.

18. The chipset of claim 15, wherein the multi-SIM is a dual-SIM.

19. The chipset of claim 15, wherein each of the first timeslot and the second timeslot is periodic and of a fixed duration.

20. A non-transitory computer-readable recording medium storing instructions configured to perform a method by a processor, the method comprising:
performing a packet-based activity on a first SIM of the multi-SIM device for a first timeslot provided by a first timer;
performing a cell-search activity on a second SIM of the multi-SIM device for a second timeslot provided by the second timer; and
performing the packet-based activity for the first timeslot and the cell-search activity for the second timeslot by alternately switching between the first timer and the second timer.
